(19) United States
(12) Patent Application Publication
(10) Pub. No.: US 2024/0262950 A1
(43) Pub. Date: Aug. 8, 2024

(54) POLYURETHANE FOAMS COMPRISING PHASE CHANGE MATERIALS

(71) Applicant: AUCKLAND UNISERVICES LIMITED, Auckland (NZ)

(72) Inventors: Charles Arienrhi IKUTEGBE, Auckland (NZ); Mohammed Mehdi FARID, Auckland (NZ)

(73) Assignee: AUCKLAND UNISERVICES LIMITED, Auckland (NZ)

(21) Appl. No.: 18/561,798

(22) PCT Filed: May 17, 2022
(86) PCT No.: PCT/NZ2022/050058

§ 371 Date: Nov. 17, 2023

(30) Foreign Application Priority Data
May 18, 2021 (NZ) 776212

(51) Int. Cl. C08G 18/08; C08K 5/01; C08K 5/092; C08K 5/101; C09K 5/06

(52) U.S. Cl. CPC C08G 18/14; C08K 5/01; C08K 5/092; C08K 5/101; C09K 5/063; C08G 2110/0025; C08G 2110/0066; C08K 2201/00

(57) ABSTRACT

The invention disclosed herein relates to a rigid foam composite comprising a polyurethane and a phase change material (PCM), wherein the PCM is present in the composite at a concentration of greater than 25 weight % relative to the weight of the composite, and methods for its preparation and uses thereof.

### FIELD OF THE INVENTION

The present invention relates to composites comprising a polyurethane foam and a phase change material, methods for its preparation and uses thereof. More specifically, the invention relates to stable rigid composites comprising a polyurethane foam and a phase change material, wherein the phase change material is present in the composite at a high concentration.

### BACKGROUND

Any reference to the prior art in this specification is not to be considered an admission that such prior art is widely known or forms part of the common general knowledge in the field.

Polyurethane foams are commonly used as thermal insulating materials to reduce the rate of heat transfer through the walls, roofs and floors of buildings, vehicles, containers, packaging materials, and equipment casings.

Polyurethane is prepared via a polymerisation reaction between an isocyanate composition and a polyol composition that generates the polyurethane polymer. In polyurethane foam forming reactions, the polyurethane polymerisation reaction occurs simultaneously with a gas-forming reaction. Commonly, the gas-forming reaction involves a reaction between water (a ‘blowing agent’) and isocyanate groups to produce low thermally conducting carbon dioxide bubbles. Together, the foam-forming reactions can be allowed to take place in situ or as a ‘pour in place’ reaction. Accordingly, liquid polyurethane foam precursors can be combined and applied where the foam is desired, so that the production of the polyurethane foam expands to fill the space.

The thermal insulating properties of polyurethane foams are primarily due to the presence of a high proportion of gas bubbles in the material. Accordingly, higher density and more rigid polyurethane foams tend to have lower insulating performance compared to lower density foams. However, in many instances where insulating material is used, a higher density polyurethane foam of greater rigidity is required.

Phase change materials (PCMs) are materials that are used to absorb, store, and release thermal energy by taking advantage of the material's phase transition that occurs at or around a desired temperature. Organic PCMs typically store and release energy relating to the heat of fusion—i.e. the breaking and formation of intermolecular bonds in the transition between solid and liquid states.

The incorporation of PCMs into polyurethane foams has the potential to be an alternative or additional option for improving thermal insulation performance of polyurethane foams, particularly higher density, rigid polyurethane foams.

PCMs can be incorporated into polymer foams in an encapsulated or non-encapsulated form. Encapsulated PCMs comprise a PCM core and an outer shell (e.g. an encapsulating agent such as a polymer or inorganic outer shell) to maintain the shape of the PCM and prevent the encapsulated PCM from leaking during the phase change process. However, the use of encapsulated PCMs is disadvantaged by the cost of encapsulation and the negative environmental effects caused by the use of encapsulating materials. In addition, the presence of an encapsulating agent means that there is a relatively lower amount of PCM that can be incorporated into the substrate, compared to use of non-encapsulated PCMs.

It would therefore be preferable to use non-encapsulated PCM in a substrate in order to reduce cost and increase the loading of PCM. However, the use of non-encapsulated PCMs in substrates raises problems in the manufacture of the substrate and in achieving an acceptable stable lifetime of the substrate.

The incorporation of non-encapsulated PCMs into polyurethane foams can degrade the strength and density of the polyurethane foam, reduce the stability of the foam, and/or fail to distribute the PCM material throughout the polyurethane foam appropriately. These problems are exacerbated where the PCM loading is increased.

Substrates comprising non-encapsulated PCM material can undergo migration of the PCM material through the substrate as the PCM material cycles between phases, such that PCMs may leak out from a porous substrate, such as a rigid polyurethane foam, in the phase transition process. In this way, PCM may accumulate on the surface of the substrate.

It is therefore an object of the present invention to provide a rigid polyurethane foam composite comprising PCM materials that overcomes or ameliorates one or more of the abovementioned problems, or to at least provide a useful alternative to existing polyurethane foams or PCM-containing materials.

### SUMMARY OF THE INVENTION

In a first aspect, there is provided a rigid foam composite comprising:
a. a polyurethane; and
b. a phase change material (PCM)
   wherein the PCM is present in the composite at a concentration of greater than 25 weight % relative to the weight of the composite. The PCM may be present in the composite at a concentration of greater than 30 weight %, greater than 40 weight %, greater than 50 weight %, or greater than 60 weight % relative to the weight of the composite. The PCM may be present in the composite in an amount between 25 to 60 weight %.

The PCM may be distributed through the composite, for example, the PCM may be uniformly distributed through the composite.

The density of the composite may be between 100 kg/m³ and 800 kg/m³. The composite preferably has a density of at least 200 kg/m³, or between 200 kg/m³ and 500 kg/m³. More preferably, the density of the composite is at least 300 kg/m³, or between 300 kg/m³ and 500 kg/m³.

The composite may have a compressive strength of at least 50 kPa, or at least 60 kPa, or at least 70 kPa, or at least 80 kPa, or at least 90 kPa, or at least 100 kPa, wherein the compressive strength is the force required to compress a 100 mm³ cube of composite by 10%, when the force is applied parallel to the rise of the foam.

The thermal stability of the composite is such that, after an initial mass loss period, the composite exhibits further mass loss of less than 1 wt. %. Preferably the mass loss is measured following a testing protocol comprising weighing the composite, washing the composite in hexane for two hours, heating at 50° C. for 14 days, then re-weighing the composite. The initial mass loss period is usually within the first three days of heating at 50° C. For example, the composite exhibits a mass loss of less than 1 wt. %, wherein the mass loss is measured after an initial mass loss period of three days of heating at 50° C.

The energy density of the composite may be at least 50 KJ/kg. For example, the energy density of the composite may be at least 50 KJ/kg, when measured by differential scanning calorimetry (DSC). In some embodiments, the energy density of melting of the composite may be at least 60 KJ/kg, or at least 70 KJ/kg, or at least 80 KJ/kg, or at least 90 KJ/kg, or at least 100 KJ/kg.

In embodiments where the PCM is a fatty acid ester, the energy density may be at least 50 KJ/kg, or at least 55 KJ/kg, or up to 59.4 KJ/kg. In embodiments where the PCM is a paraffin, the energy density may be at least 60 KJ/kg, or at least 70 KJ/kg, or at least 80 KJ/kg, or at least 90 KJ/kg, or at least 100 KJ/kg, or at least 110 KJ/kg.

The composite may comprise the reaction product of a mixture wherein the mixture comprises a PCM, an isocyanate and a fast-reacting polyol composition. In some embodiments, the fast-reacting polyol composition has a hydroxyl value of at least 100 mg KOH/g or between 100 and 600 mg KOH/g, or between 100 and 300 mg KOH/g.

The fast reacting polyol composition may have a polyol functionality of between 1.5 and 8. The fast reacting polyol composition may comprise a polyol selected from the group consisting of: a polyether polyol, an amine-terminated polyol, propylene glycol, glycerol, trimethylolpropane, triethanolamine, pentaerythritol, sorbitol, sucrose, sorbitol initiated polyether polyols, sucrose initiated polyols, sucrose initiated polyether polyols, pentaerythritol initiated polyols, triethanolamine initiated polyols, triethanolamine-initiated polyether polyol, polyether polyamine polyols. Preferably, the amine-terminated polyol comprises terminal groups selected from ethylene diamine, toluene diamine, diphenylmethane diamine, and diethylenetriamine.

The isocyanate composition may comprise an isocyanate selected from the group consisting of: methylene diphenyl diisocyanate, bis(4-isocyanatophenyl)methane, combinations or co-polymers comprising diphenylmethane diisocyanate, 4,4′-diphenyl methane diisocyanate, chlorophenylene diisocyanate, toluene diisocyanate, 2,4-toluene diisocyanate, 2,6-toluene diisocyanate, hexamethylene diisocyanate, diphenylmethane diisocyanate, isocyanate terminated polybutadiene, isocyanate terminated polyolefins, 4,4′-diphenylmethane diisocyanate, 2,4′-diphenylmethane diisocyanate or a quasi-prepolymer that comprises any of the above isocyanates.

The isocyanate composition may comprise a polyisocyanate with an isocyanate functionality of at least 2.2, and/or an isocyanate content of at least 27%.

The composite may comprise the reaction product of a mixture wherein the mixture comprises a PCM, an isocyanate, a fast-reacting polyol composition and a high density polyol composition. In some embodiments the high density polyol composition has a hydroxyl value of between 160 and 800 mg KOH/g, or between 300 mg KOH/g and 800 mg KOH/g.

The fast reacting polyol composition and high density polyol composition are preferably present in the reactant mixture in a ratio of between 3:1 and 1:3 (by weight). The ratio of the fast reacting polyol composition to the high density polyol composition may be between 2.5:1 and 1:2.5, or between 2:1 and 1:2, or between 1.5:1 and 1:1.5 (by weight). In some embodiments, the ratio of the fast reacting polyol composition to the high density polyol composition may be about 1:1 (by weight).

Preferably, the reactant mixture has a cream time of less than 60 seconds.

Preferably, the PCM is a non-encapsulated PCM. The PCM is therefore directly encapsulated by the polyurethane in the rigid foam composite. The PCM may be selected from the group consisting of hydrocarbons (paraffins), fatty acids, and fatty acid esters.

The PCM phase transition temperature may be within the range of −20 to 100° C., or between 18 to 27° C., or between −20 and 4° C. The particular PCM phase change temperature will depend on the purpose of the composite.

In a second aspect, there is provided a method for the preparation of a rigid foam composite comprising a polyurethane and a phase change material (PCM), the method comprising the combination of a fast reacting polyol composition, a high density polyol composition, an isocyanate composition, and a PCM, to produce a rigid polyurethane foam composite, wherein the total weight of the PCM is at least 25% of the total weight of the composite.

Preferably the total weight of the PCM is greater than 30 weight %, greater than 40 weight %, or greater than 50 weight %, or greater than 60 weight % of the total weight of the composite.

The method preferably comprises the direct addition of the PCM to the fast reacting polyol composition, the high density polyol composition, and/or isocyanate composition and/or a reactant mixture of the polyol compositions and isocyanate composition.

The PCM is preferably a non-encapsulated PCM. The method preferably comprises the direct encapsulation of the PCM by the polyurethane.

Preferably, the fast reacting polyol composition and high density polyol composition are combined with the other reactants in a ratio of between 3:1 and 1:3 (by weight). The ratio of the fast reacting polyol composition to the high density polyol composition may be between 2.5:1 and 1:2.5, or between 2:1 and 1:2, or between 1.5:1 and 1:1.5 (by weight). In some embodiments, the ratio of the fast reacting polyol composition to the high density polyol composition may be about 1:1 (by weight).

Preferably, the method comprises selecting the fast reacting polyol composition, the high density polyol composition, and the isocyanate composition such that the reaction between the polyol compositions and the isocyanate composition has a cream time of less than 60 seconds.

The method may comprise combining the polyol compositions, isocyanate composition and PCM in the presence of one or more of catalysts, blowing agents (optionally including water), and fire retardants.

In a third aspect, there is provided a rigid foam composite prepared according to the method as described herein.

In a fourth aspect, there is provided a kit for preparing a rigid foam composite, the kit comprising:
a fast reacting polyol composition;
a high density polyol composition;
an isocyanate composition; and
a phase change material (PCM);
   wherein the PCM is present in an amount greater than 25 weight % relative to the total weight of the fast reacting polyol composition, high density polyol composition and isocyanate composition.

### BRIEF DESCRIPTION OF THE FIGURES

FIG. 1 shows a differential scanning calorimetry thermograph of Composite 17 described in Example 7.

FIG. 2 shows a differential scanning calorimetry thermograph of Composite 29 described in Example 7.

FIG. 3 is a graph showing the mass loss of Composite 35, described in Example 7, when placed in the oven at 50° C. for 273 days.

FIG. 4 is a graph showing the mass loss of Composite 36, described in Example 7, placed in the oven at 50° C. for two weeks, following the thermal stability test protocol described herein, compared to a control rigid polyurethane composite without PCM (dashed line), and a sample of the PCM (dotted line).

FIG. 5 is a graph showing the mass loss of Composite 37, described in Example 7, placed in the oven at 50° C. for two weeks, following the thermal stability test protocol described herein, compared to a control rigid polyurethane composite without PCM (dashed line), and a sample of the PCM (dotted line).

FIG. 6 is a graph showing the mass loss of coated Composites 9, 10 and 11, described in Example 6, placed in the oven at 50° C. for 30 days.

FIG. 7 shows the mechanical properties of rigid polyurethane foams incorporating different PCM contents (flexural strength) described in Example 9.

FIG. 8 shows the mass loss profile of the rigid foam composite described in Example 10.

FIG. 9 shows the thermal performance of buildings with and without rigid polyurethane foams incorporating PCM described in Example 11.

FIG. 10 shows the interior cabinet temperature of an unpowered refrigerator with and without PCM foam described in Example 12.

### DETAILED DESCRIPTION

There is provided a rigid composite material comprising a PCM incorporated in a polyurethane foam. There is further provided a method for the preparation of the rigid composite material.

### Definitions

As used in this specification, the words “comprises”, “comprising”, and similar words, are not to be interpreted in an exclusive or exhaustive sense. In other words, they are intended to mean “including, but not limited to”.

The hydroxyl number, or hydroxyl value, of a polyol is a measurement of the content of hydroxyl present in the polyol. The hydroxyl number is the amount, in milligrams, of potassium hydroxide that is equivalent to the hydroxyl content in 1 gram of polyol (i.e. mg KOH/g). Methods for determining the hydroxyl number of a polyol are well known.

The polyol functionality (f) is defined by the number of hydroxyl groups per molecule.

The hydroxyl number and polyol functionality are related by the following equation:

$$f = \frac{{M}_{w ( polyol )} \times {OH}_{n o}}{{M}_{w ( K O H )}}$$

where M_{w(polyol)} and M_{w(KOH)} are the respective molecular weights of the polyol and potassium hydroxide.

Isocyanate (or NCO) functionality refers to the average number of isocyanate groups per molecule of a polymeric isocyanate. Methods for determining isocyanate functionality are well known.

Isocyanate content refers to the concentration of the active isocyanate groups, and is typically expressed as a percentage. For example, isocyanate content can be determined by the following equation: Isocyanate content % NCO=4202/NCO equivalent weight.

“Cream time” is the period from the combination of the polyurethane reactants to the point at which a lightening of the colour of the polyurethane reactant mixture and an increase in volume of the reaction composition is observed. As used herein, the cream time is determined according to ASTM-D7487 “Standard Practice for Polyurethane Raw Materials: Polyurethane Foam Cup Test”.

### Composite

The rigid foam composite of the present invention comprises a polyurethane foam and a PCM.

It has been found that rigid foam composites described herein are capable of stabilising a high loading of PCM. In particular, it has been found that they are capable of stabilising a high loading of non-encapsulated, organic PCMs. The PCMs remain stabilised over repeated temperature cycles through the PCM phase transition temperature.

The rigid foam composite comprises a stabilised PCM within a cured polyurethane polymer network. The polyurethane network produced by the curing reaction between the polyol and an isocyanate compositions described herein stabilises the PCM by preventing leakage of the PCM from the composite at normal operating temperatures of the composite (i.e. between −20° ° C. and)100° ° C.

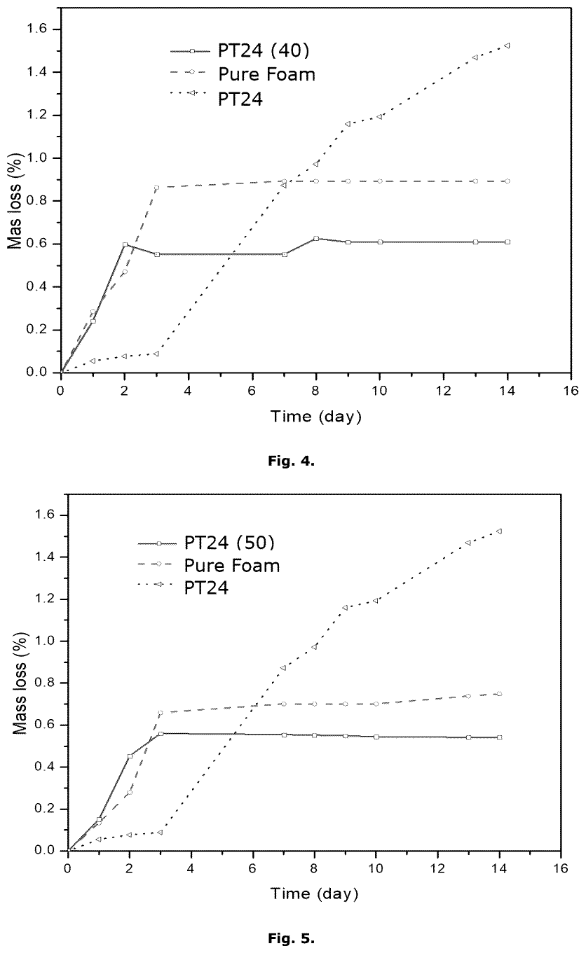

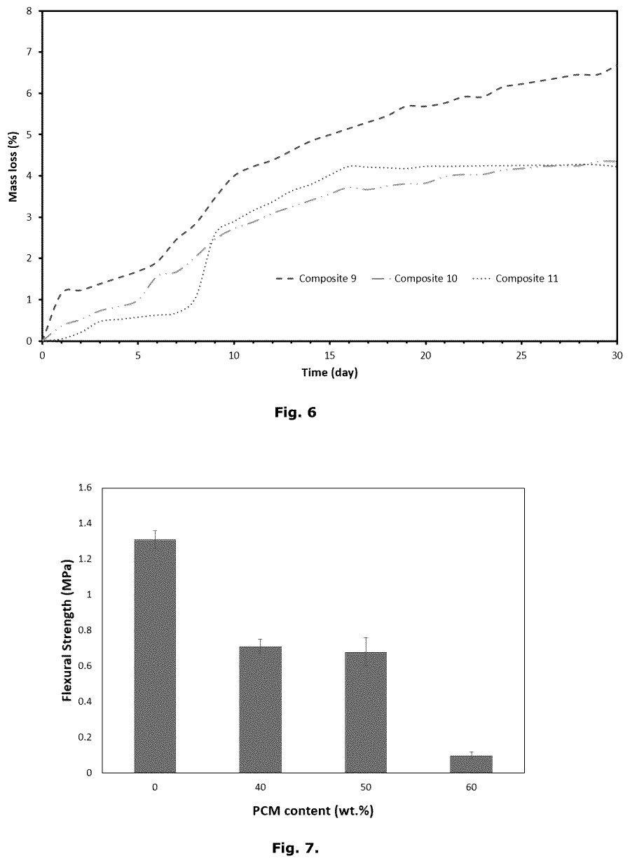

Preferred embodiments composites of the present invention have been found to lose less than or equal to 1 mass % during repeated temperature cycling through the phase transition temperatures of the PCM. Composites having a low level of mass loss indicate good encapsulation of the PCM by the polyurethane in the composite, conferring good durability and a suitable lifetime to the composites. FIGS. 3 to 5 show mass measurements of several composites of the present invention, in which the composites maintained a stable weight following an initial mass loss period of less than or equal to 1% where the composites were heated for an extended period of time. FIG. 6 (see Example 6) shows a mass measurement of composites prepared from a fast reacting polyol composition and a polyol that is not a high density polyol composition (Ecofoam GP330 polyether polyol), in which the composites underwent mass loss that did not stabilise following an initial period. This is indicative of composites in which the PCM is not well encapsulated by polyurethane.

An initial period of mass loss under the mass loss protocol described in the Examples is acceptable when the mass of the composite stabilises following an initial period. The initial period of mass loss may be attributable to the presence of unreacted polyol and isocyanate, PCM on the surfaces of the composite, and to the loss of volatile compounds. More important is the stabilisation of the mass of the composite following the initial period. For example, in Example 8, some composites underwent an initial period of mass loss that was greater than 1 wt. %, but were still considered suitable for use because the mass loss stabilised after an initial period.

The initial mass loss period may be considered to be the first three days of heating according to the protocol described herein. FIGS. 3 to 5 indicate that, following the first three days of heating, the mass of the composite stabilises.

It is an aim of the present invention to provide a composite comprising a high proportion of PCM. The greater the proportion of PCM, the greater the capacity of the composite to absorb, store, and release thermal energy. The PCM is present in the composite at a concentration of greater than 25 wt. % of the total weight of the composite. The concentration of PCM may be greater than 30 wt. %, greater than 35 wt. %, greater than 40 wt. %, greater than 45 wt. %, or greater than 50 wt. % of the total weight of the composite.

The PCM may be uniformly distributed through the composite. This may be achieved by adequate mixing of the PCM into one or both of the polyurethane reactant compositions (e.g. polyol compositions and/or isocyanate compositions) prior to combination to form the rigid foam composite.

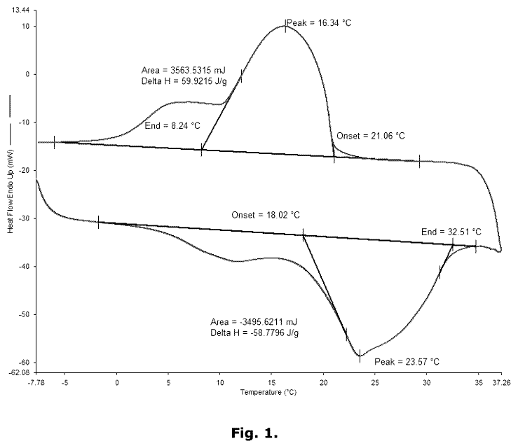

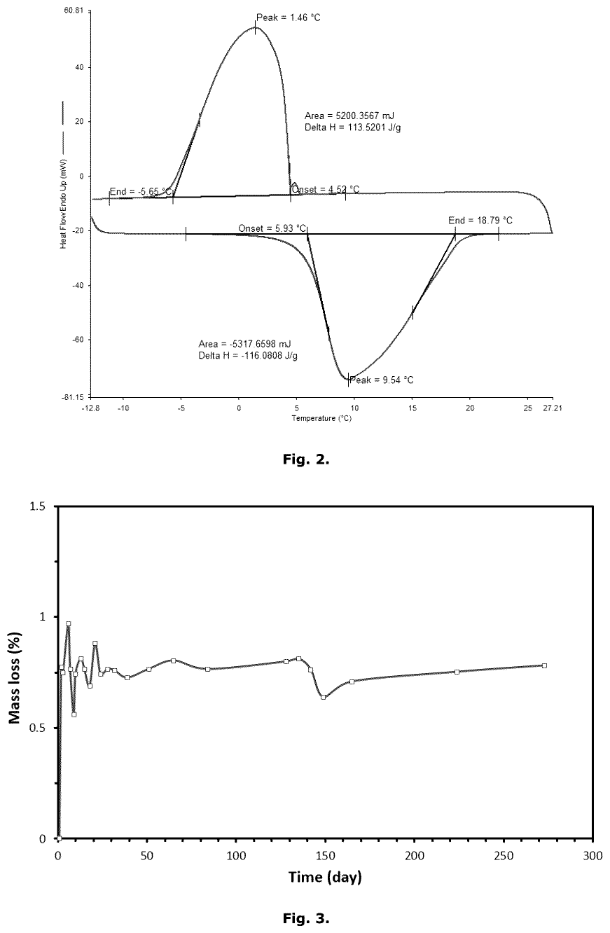

Energy density and latent heat of the PCM and composites may be measured by differential scanning calorimetry (DSC). DSC measurements for rigid foam composites of the present invention (see the Examples and FIGS. 1 and 2) show the composites can absorb, store and release thermal energy well, and have good thermal stability. The composites of the present invention may have an energy density of at least 50 KJ/kg, at least 55 KJ/kg, at least 60 KJ/kg, at least 65 KJ/kg, at least 70 KJ/kg, at least 75 KJ/kg, at least 80 KJ/kg, at least 85 KJ/kg, at least 90 KJ/kg, at least 95 KJ/kg, at least 100 KJ/kg, at least 105 KJ/kg, at least 110 KJ/kg, at least 115 KJ/kg, at least 120 KJ/kg, or at least 125 KJ/kg.

The composite of the present invention may have a density of between 100 kg/m³ and 800 kg/m³. Densities of at least 100 kg/m³ may be achieved by the use of a fast reacting polyol composition and a high density polyol composition. The preferred density of the composite is at least 200 kg/m³, or between 200 kg/m³ and 500 kg/m³. More preferably, the density of the composite is at least 300 kg/m³, or between 300 kg/m³ and 500 kg/m³. The density of the composite is important because it affects the volumetry energy density. A higher density composite is preferred because it comprises a higher density of PCM. While this reduces its thermal insulating properties, that is offset by the greater density of PCM and corresponding greater volumetric energy density, which increases the ability of the composite to absorb, store and release thermal energy by the composite. For example, a composite of the present invention having a density of 300 kg/m³ comprising 50% PCM with a latent heat of about 200 KJ/kg would have a volumetric energy density of about 30,000 KJ/m³. Example 4 describes a composite with a density of 278 kg/m³, comprising 50% PCM with a latent heat of 161.9 KJ/kg (PT24) showed a volumetric energy density of about 21,000 KJ/m³.

Tests of compressive strength of the composite of the present invention involve the determination of the force required to compress a 100 mm³ cube of foam by 10%, when the force is applied parallel to the rise of the foam. Preliminary studies carried out on the composites of the present invention showed compressive strength of the composite as at least 50 kPa, at least 60 kPa, at least 70 kPa, at least 80 kPa, at least 90 kPa and at least 100 kPa.

### PCM

Whilst phase change materials including organic, inorganic and eutectic PCMs are envisaged as within the scope of the present invention, organic PCMs are preferred including paraffin-based (e.g. aliphatic hydrocarbons) and non-paraffin PCMs (e.g. fatty acids and their esters, and lipids).

Organic PCMs take advantage of the phase transition between their solid and liquid states. The transition between solid and liquid is endothermic, and thus absorbs thermal energy from its surroundings. The reverse transition between liquid and solid is exothermic, and thus releases thermal energy to its surroundings. Therefore, the transition temperature of the PCM is preferably at or around the desired temperature of the substrate. For the purposes of this application, the phase transition temperature is determined by differential scanning calorimetry according to ASTM D3418.

The PCMs, and in particular organic PCMs, may have a latent heat of at least 100 KJ/kg, at least 110 KJ/kg, at least 120 KJ/kg, at least 130 KJ/kg, at least 140 KJ/kg, at least 150 KJ/kg, at least 160 KJ/kg, at least 170 KJ/kg, at least 180 KJ/kg, at least 190 KJ/kg, at least 200 KJ/kg, at least 210 KJ/kg, at least 220 KJ/kg, at least 230 KJ/kg, at least 240 KJ/kg, or at least 250 KJ/kg.

The phase transition temperature of PCMs suitable for the present invention may be between −20 and 100° C. One example of a preferred range of PCM phase transition temperatures is between 18 and 27° C., for example for use in buildings. An alternative example of a preferred range of PCM phase transition temperatures is between −20 and 4° C., for example in refrigerated applications.

The phase change materials selected for the composite of the present invention will in part depend on the purpose of the composite and the desired phase transition temperature.

Human comfort temperatures generally lie between 18 and 27° C. Accordingly PCMs having a phase transition temperature within the human comfort range are suitable for incorporation into composites for use in human-occupied compartments such as buildings or vehicles.

Refrigerated containers and packaging have tend to have target temperatures between −20° C. (for storing or transporting frozen materials) and about 4° C. (for storing or transporting refrigerated materials). Accordingly, PCMs having target temperatures at or near refrigeration or freezer temperatures are required for composites used in these applications. In some cases, insulated packaging is intended to slow the rate of heat transfer through the walls of the insulated packaging. In these cases, PCMs having a phase transition temperature lying between the original internal temperature and the external temperature is required.

Whilst encapsulated and non-encapsulated PCMs are envisaged as within the scope of the present invention, it has been found that non-encapsulated PCMs may be used in the composite of the present invention without significant mass loss or visible degradation of the composite over phase change cycles. In particular, it has been found that non-encapsulated organic PCMs may be used in the composite of the present invention without significant mass loss of PCM over phase change cycles. Non-encapsulated PCMs are PCMs that do not comprise an outer shell or casing.

Examples of organic compounds that are suitable to be used as PCMs in the composites of the present invention include organic compounds with a melting or softening point at a temperature that corresponds with the desired temperature of the substrate. Suitable PCMs are preferably non-reactive with polyols or isocyanates, and preferably non-reactive with common additives to polyurethane composites, such as polymerisation catalysts (e.g., organotin catalysts and tertiary amines), blowing agents (e.g., water and auxiliary blowing agents) or fire retardants. PCMs are preferably non-photosensitising and non-photoreactive. Particularly where non-encapsulated PCMs are used in the preparation of the composite, the PCM preferably does not comprise reactive functional groups capable of reaction with an isocyanate or polyol.

More specific examples of suitable PCMs include hydrocarbons (e.g. paraffins), organic waxes, silicone waxes, fatty acids, fatty acid esters, derivatives of vegetable oils or plant oils, and derivatives of animal fats. In some embodiments, the PCM may be organic non-paraffin-based type which may comprise of or derive from animal fat and/or oil from vegetable sources. Preferred non-paraffin based PCMs include fatty acids and fatty acid esters.

### Isocyanate Composition

Suitable isocyanates include organic isocyanates such as polyisocyanates (e.g. polymeric diphenylmethane diisocyanate), methylene diphenyl diisocyanate, bis(4-isocyanatophenyl)methane, combinations or co-polymers comprising diphenylmethane diisocyanate, 4,4′-diphenyl methane diisocyanate, chlorophenylene diisocyanate, toluene diisocyanate, 2,4-toluene diisocyanate, 2,6-toluene diisocyanate, hexamethylene diisocyanate, diphenylmethane diisocyanate, isocyanate terminated polybutadiene, isocyanate terminated polyolefins, 4,4′-diphenylmethane diisocyanate, 2,4′-diphenylmethane diisocyanate.

Where the isocyanate is a polyisocyanate, these may have an isocyanate functionality of at least 2.2, and/or an isocyanate content of at least 27%. Preferred isocyanates have an isocyanate functionality of at least 2.6 and/or an isocyanate content of at least 30%, although isocyanates having an isocyanate functionality of between 2.2 and 2.5 and an isocyanate content of between 27% and 33% are also suitable.

The isocyanate may comprise a quasi-prepolymer that comprises any of the above isocyanates. Quasi-prepolymer isocyanates are aliphatic or aromatic isocyanates that combine with other isocyanates. Typical isocyanate values of quasi-prepolymers are ˜15-16%, viscosity 253-1300 centipoise. Examples of quasi-prepolymers include Rubinate 9009 MDI, Rubinate 9480 MDI and Suprasec 9524 MDI. The isocyanate values of ˜15-16% is not the final value of the isocyanate but that of the quasi-prepolymer only. When quasi-prepolymers are combined with other isocyanates, the final isocyanate value is preferably at least 30% and the isocyanate functionality is preferably at least 2.6.

### Polyol Composition

Polyols are organic compounds having two or more hydroxyl functional groups. Polyols used in the preparation of polyurethanes polyols often further comprise other functional groups, such as amine groups. Examples of polyols within the scope of the present invention include fast reacting amine-terminated low-density polyols, fast reacting amine-initiated high-density polyols, slow reacting high free rise-density polyols, fast reacting high free rise density polyols, polyether polyamine polyols, sucrose-initiated polyether polyols and sorbitol-initiated polyether polyols.

The composite material may comprise a reaction product of a reactant mixture wherein the reactant mixture comprises an isocyanate and a fast reacting polyol composition. Example 1 shows that a rigid foam composite comprising 25 weight % non-encapsulated PCM can be prepared by the combination of a fast reacting polyol composition (Endurathane SR42M, cream time <10 seconds), an isocyanate composition and the PCM. Example 2 shows that the use of a polyol composition that has a slower cream time (Ecofoam GP330, cream time 35 seconds) produces a lower quality composite product.

Examples 1 and 8 show that the use of only fast reacting polyol compositions in the preparation of polyurethane composites become unfeasible where the PCM content is increased beyond 25 weight %. For example, composites 1A, 1B (Example 1) and 41 (Example 8) were reaction products of a reactant mixture in which the polyol composition only comprised a fast reacting polyol. Where composite 1A (which comprised 25 weight % PCM) was a thermally stable material, 1B and 41 (both comprising greater than 25 weight % PCM) were both of poor quality and underwent substantial mass loss in thermal stability testing.

The composite material may comprise a reaction product of a reactant mixture wherein the reactant mixture comprises an isocyanate and a fast reacting polyol composition and a high density polyol composition. Examples 3 to 5, 8 and 9 show that rigid foam composites comprising higher loadings of PCM, (e.g. 40 or 50 weight % PCM) can be achieved by the combination of a fast reacting polyol composition, a high density polyol composition, an isocyanate composition, and the PCM. These examples show that both the fast reacting polyol composition and the high density polyol composition are required to achieve a rigid foam composite having good stability and durability when the PCM loading is increased.

### Fast Reacting Polyol Composition

In the polyurethane manufacturing field, polyol compositions may be classified as a fast reacting polyol (FRP) composition or a high density polyol (HDP) composition.

A fast reacting polyol composition is characterised by being highly reactive and having a rapid cream time when reacted with an isocyanate composition. Typical cream times for fast reacting polyol compositions are less than 10 seconds and gel time of not greater than 30 seconds when reacted with isocyanate having an NCO content of about 30% (+3%) and average functionality of 2.55 (+0.35).

Fast reacting polyol compositions are commonly used for spray foam application of polyurethanes. When reacted with an isocyanate composition, fast reacting polyol compositions form low density polyurethane foams. Free rise densities for polyurethanes produced by fast reacting polyols are less than 60 kg/m³, more typically less than about 40 kg/m³, for example between about 30 to 60 kg/m³.

The fast reacting polyol compositions used in the Examples described herein have hydroxyl values of at least 100 mg KOH/g. In some embodiments, the fast reacting polyol compositions may have a hydroxyl value of between about 100 and 600 mg KOH/g, for example between 100 and 300 mg KOH/g. Fast reacting polyol compositions may have molecular weights in the range of 1 and 50,000 g/mol, and a hydroxyl functionality of greater than 1.5, and less than 8.

The fast reacting polyol compositions may comprise polyols selected from the group consisting of: a polyether polyol, amine-terminated polyol, propylene glycol, glycerol, trimethylolpropane, triethanolamine, pentaerythritol, sorbitol, sucrose, sorbitol initiated polyols, sorbitol initiated polyether polyols, sucrose initiated polyols, sucrose initiated polyether polyols, pentaerythritol initiated polyols, triethanolamine initiated polyols, and polyether polyamine polyols. Examples of suitable amine-terminated polyols include polyols with terminal groups selected from ethylene diamine, toluene diamine, diphenylmethane diamine, and diethylenetriamine.

The fast reacting polyol compositions comprise one or more catalysts for increasing the rate of polymerisation and/or gas generation. Examples includes tertiary amine catalysts and organometallic catalysts.

Examples of commercial fast reacting polyol compositions suitable for the present invention include Endurathane SR42M (Polymer Group Limited, Auckland, New Zealand) and Endurathane SR43S (Polymer Group Limited, Auckland, New Zealand).

### High Density Polyol Composition

It has been found that higher loadings of PCM may be stabilised in rigid polyurethane foam composites by the use of a combination of polyol compositions, namely a fast reacting polyol composition, and a high density polyol composition.

High density polyol compositions typically comprise polyether polyols and/or polyester polyols. In the polyurethane manufacturing field, high density polyol compositions are not considered suitable for spray foam application. High density polyol compositions are often used in the manufacture of high density rigid polyurethane materials, such as boards, a core in laminated insulation panels, and in load bearing supports. High density polyol compositions can be used to produce polyurethane materials with a good surface finish and cell structure.

Compared to fast reacting polyol compositions, high density polyol compositions are characterised by long cream times. Typical cream times for high density polyol compositions are greater than 30 seconds, more commonly greater than 40 seconds. For the present invention, preferred high density polyol compositions have a cream time of at least 10 seconds, more preferably greater than 30 seconds, when combined with an isocyanate composition having an isocyanate content of about 30% (+3%) and average isocyanate functionality of 2.5 (+0.35). Free rise densities for polyurethanes produced by high density polyol compositions are greater than 60 kg/m³.

The high density polyol compositions used in the Examples described herein have hydroxyl values of at least 300 mg KOH/g. However, it is considered that high density polyol compositions suitable for the present invention may include polyols having a hydroxyl value of at least 160 mg KOH/g, at least 200 mg KOH/g, or at least 250 mg KOH/g.

The high density polyol compositions used in the Examples described herein have a polyol functionality number of between 1.6-4.8. However, it is considered that high density polyol compositions suitable for the present invention may include polyols having a polyol functionality of between 1.5 and 5.

Examples of commercial high density polyol compositions suitable as a high density polyol composition include R-Foam 100 and R-Foam 200 (Barnes, New South Wales, Australia), Foam-iT™ 10 and Foam-iT™ 5 (Smooth-On, USA).

### Mixture of Polyol Compositions

The Examples (Example 8 and Tables 17 and 18 in particular) show that composites with higher levels of PCM (e.g. 40 or 50 weight %) comprising only one of a fast reacting polyol composition or a high density polyol composition gave poorly finished products whereas composites prepared from a fast reacting polyol composition and high density polyol composition were of higher quality as they provided improved PCM entrapment and high energy density.

The proportion of fast reacting polyol composition and high density polyol composition in the composite may be about 1:1, based on respective weights of the fast reacting polyol composition and high density polyol composition. Ratios of between 3:1 and 1:3, or between 2:1 and 1:2, or between 1.5:1 and 1:1.5 (FRP: HDP) are suitable for the present invention.

The fast reacting polyol composition and high density polyol composition may be combined prior to their use in the preparation of the rigid foam composite. Alternatively, the fast reacting polyol composition and high density polyol composition may be stored separately and combined at the time of reaction with the isocyanate composition.

In preferred embodiments, the PCM is combined with either or both polyol compositions to form an isocyanate reactive composition, prior to the combination of the polyol composition with the isocyanate.

### Blowing Agents

Blowing agents, including water and non-reactive auxiliary blowing agents, may be used to control the density of the polyurethane composite. The blowing agents may be combined with the polyol composition(s), or added to the reactant mixture.

### Catalysts

One or more catalysts may be added in the preparation of the composite to accelerate the rate of the water-isocyanate reaction, which produces carbon dioxide gas. One or more catalysts may be added to accelerate the rate of polymerisation of the polyurethane polymer, and reduce the cream time in the preparation of the composite. The presence of catalysts may be useful in achieving the desired rates of the simultaneous polymerisation and gas-formation reactions.

Catalysts may be added to the polyol composition(s), or added to the combination of polyol composition(s) and isocyanate composition(s) at the time of reaction. Polymerisation catalysts suitable for this purpose are well known in the art, and include tertiary amines and organometallic catalysts. The polymerisation catalysts may be present in an amount of between 0.01 and 10 wt. %, based on the total weight of the rigid foam composite.

### Fire Retardants

One or more fire retardants may be added in the preparation of the composite. Suitable fire retardants for the composite of the present invention include fire retardants used in polyurethane foams, examples of which are well known in the art.

Alternatively, one or more fire retardants may be applied to the prepared rigid foam composite. For example, the polyurethane composite may comprise a layer of fire retardant material applied to the polyurethane composite.

### Method of Preparation

The rigid foam composite of the present invention is prepared by combining the polyol composition(s), isocyanate composition and PCM to produce the rigid foam composite comprising a polyurethane foam in which PCM particles are distributed.

As is well known in the art, rigid polyurethane foams may be prepared by the combination of a polyol and an isocyanate, typically in the presence of one or more catalysts, and one or more blowing agents (such as water and optionally additional auxiliary blowing agents). The composite reactant mixture formed by the combination of these compositions may be prepared directly on a substrate, or the composite reactant mixture may be applied to the substrate directly after combination of the reactants.

After application of the composite reactant mixture to a substrate and initiation of the polymerisation reaction, the reactant mixture is allowed to stand and form the rigid foam composite. The time for forming the composite may be less than 72 hours, less than 48 hours, less than 24 hours, less than 12 hours, less than 6 hours, less than 3 hours, or less than 1 hour.

Ideally, the preparation, and choice of reactants, of the composite balances the foam forming reaction (being the generation of gas bubbles) and the curing reaction (being the isocyanate/polyol reaction to produce polyurethane) such that a composite material achieves the desired density as well as a polymer network that is capable of immobilising the entrained PCM.

An example of a method of preparing and applying the rigid foam composite is by the use of a polyurethane spray foam system, which combines the polyol compositions and isocyanate composition together in a continuous flow, and directly thereafter sprays the combination onto a substrate for curing.

The present invention allows for the direct incorporation of PCM, including non-encapsulated organic PCM, into the polyol composition(s) or isocyanate composition prior to combination and reaction of the reactant mixture to effect curing of the polyurethane in the rigid foam composite. Whilst the PCM is preferably combined with the polyol composition(s), the PCM could also be combined with the isocyanate composition, or the PCM could be combined with both the polyol composition(s) and isocyanate composition. Alternatively, the PCM may be separately added to the polymerisation reactant mixture at the initial stages of the polymerisation reaction. The components of the composite should be combined such that the PCM is distributed, ideally evenly distributed, throughout the composite. For example, the polyol composition(s) may include a PCM. The polyol compositions may comprise 1-99 wt. % PCM (by weight). Alternatively, or in addition, the isocyanate may include a PCM. The isocyanate composition may comprise 1-99 wt. % PCM (by weight of the isocyanate).

It is preferred that the PCM is melted prior to addition. It is also preferred that the PCM is melted during the polymerisation reaction. During the polymerisation reaction, the temperature of the reaction increases as the reaction progresses until a maximum reaction temperature is attained. Hence, the reaction does not need to be performed at temperatures below those of PCM melting point. It is preferred that the one or more polyol composition(s) and isocyanate composition be warmed up to about 40 to 45° C. before they are combined. It is further preferred that the reactant mixture is maintained at about 40 to 45° C.

The polyol composition(s) and isocyanate composition are combined in a ratio of approximately 1:1. Typically, the polyol and isocyanate compositions are combined based on equivalents of hydroxyl groups in the one or more polyols and equivalents of isocyanate groups. The ratio of polyol to isocyanate will vary depending on the nature of the polyurethane being prepared and its method of preparation. For example, and as is known in the art, an excess of isocyanate may be required where water is used as a blowing agent.

Short cream times of the reaction mixture are preferred to achieve the desired stability of the composite. Preferred cream times of the reaction mixture are preferably less than 60 seconds, more preferably less than 50 seconds, more preferably less than 40 seconds, more preferably less than 30 seconds.

### Mechanical Properties

The addition of additives in the manufacture of polyurethane is known to affect the density and strength of the resulting composite. Example 9 shows that the presence of PCM in a polyurethane composite reduces the flexural strength of the composite. Whilst composites comprising 40 and 50 wt. % PCM cause a reduction in the composite's flexural strength, the flexural strength is considered manageable and suitable for most applications of rigid polyurethane materials. Increasing the PCM proportion to 60 wt. % of the composite caused a significant reduction in the flexural strength of the composite compared to a control polyurethane sample, and to the composites comprising 40 and 50 wt. %.

### Thermal Durability

The thermal reliability of a PCM composite is dependent on the proper immobilisation and ability of the composite to prevent loss of PCM. Testing described in Example 10 shows that the composite underwent an initial mass loss before stabilising with no further loss. The results indicate that the composites of the present invention material will have durable performance over time suitable for use as building materials with long lifetimes.

### Applications

The composite of the present invention has an application as a thermal insulation material, or in combination with an insulating material. The insulation reduces heat loss or gain while the composite stores the heat or coolness and hence minimises temperature fluctuation in buildings, cold stores and in other applications. The stored energy may also be utilised at time when it is needed. The thermal insulation material may be for purposes where the desired temperature is within the human comfort range (i.e., between 18 and 27° C.). Examples of such thermal insulating material include in buildings and infrastructure. For example, the composite may be used on or in walls, wallboards, ceilings, roofing, framing, doors (including garage doors), flooring, and insulation batts. Example 11 shows the incorporation of the rigid foam composite of the present invention into building materials (comprising a PCM with a phase transition temperature of about 21° C.), in this case as a layer applied to wall boards in a building.

The composite has an application as a thermal insulation material for cold storage insulation, where the desired temperature is below 10° C., below 4° C., below 0° C., below −5° C., below −10° C., below −15° C., below −18° C., or below −20° C. Examples of thermal insulation material is in cold storage insulation, chilled food storage packaging, refrigerated transport vehicles or containers, cryogenic insulation, domestic appliance insulation (e.g. refrigerators) and portable coolers (e.g. ice boxes). Example 12 shows the incorporation of the rigid foam composite (comprising a PCM with a phase transition temperature of about 4° C.) of the present invention into a refrigerator lining.

The composite may similarly be used in thermal insulation for lining heated containers, tanks and vats.

The composite may be used in virtually any application that standard rigid polyurethanes are used in. For example, the composite may be used in building, vehicle and refrigerator insulation, packaging, and containers. It may be used in cavity-fill or moulding applications.

The composite of the present invention may be provided as a thermal insulating foam that may be directly applied to a surface of a wall board, such as GIB® Plasterboard (a paper lined plasterboard), drywall, clay-based panels, or other substrates such as plywood. In this application, the composite of the present invention is prepared and applied to a surface of the substrate and allowed to cure. The composite adheres to the substrate during curing. Alternatively, the composite may be screwed or glued to the substrate, for example where the composite is prepared or provided separately from the substrate. The thickness of the cured composite is preferably between 5 and 50 mm, or between 10 and 25 mm, or between and 15 mm.

The composite may be provided as a building panel. For example, the composite may be provided in the form of a sheet. The dimensions of the sheet may be standard dimensions for building panels used in the building industry (such the same or similar dimensions of standard plasterboards). In one example, the composite may be provided as a sheet having a thickness of 10 to 25 mm. The sheet may optionally further comprise an exterior lining, coating, skim coat, cladding or wrapper. In this example, the sheet could be used in combination with other forms of insulation, such as glass fibre, synthetic fibre, wool, polystyrene, mineral wool or polyester.

The composite may be provided as one or more layers in a bi-layered or multi-layered panel. For example, the composite may be provided as an internal or external layer of a building panel. The composite may be sandwiched between other building panels.

The composite may be used in combination with other conventional insulation material. For example, the composite may be used in combination with conventional polyurethane insulating material.

### EXAMPLES

The invention is further described with reference to the following examples. It will be appreciated that the invention as claimed is not intended to be limited in any way by these examples.

### Thermal Stability Test Protocol

The thermal stability testing and mass loss testing described in the Examples were carried out according to the following method: Pre-weighed samples of the rigid foam composites were soaked in an organic extractive solvent such as hexane for about 2 hours and weighed when dried to determine weight reduction. The composite was then placed in a temperature-controlled oven at a constant temperature higher than that of the PCM's phase transition temperature. An oven temperature of 50° C. was used to simulate extreme temperature conditions inside wall cavities. The composite is weighed daily to ascertain the rate of mass loss.

### Materials

Details of the polyol compositions and isocyanate compositions used in the Examples are shown in Tables 1 and 2. The PCMs used in the Examples were all non-encapsulated PCMs having varying melting points (i.e. phase change temperatures). Details of the PCMs are shown in Tables 3 and 4. PT-15, PT4, PT6, PT8, PT20, PT23 and PT24 were obtained from Puretemp LLC, Minneapolis, MN, USA. RT4, RT21 and RT25HC were obtained from Rubitherm Technologies GmbH, Berlin.

TABLE 1
Polyol composition properties

| | | | | Free | | | | | |
|---|---|---|---|---|---|---|---|---|---|
| Polyol | | | | rise | | | | | |
| composition | Polyol | OH | Acid | density | Specific | Viscosity | Molecular | Polyol | |
| name | type | value | value | (kg/m³) | gravity | (mPa · s) | weight | functionality | Remark |
| Endurathane SR42M | Amine | 260 | 2.1 | 30-36 | 1.14 | 630 | 280-385 | 1.3-2.0 | Cream time: 4-7 s |
| (Polymer Group | terminated | | | | (@21° C.) | (@21° C.) | | | Gel time: 10-14 s |
| Limited, New | polyol | | | | | | | | Fast reacting |
| Zealand) | | | | | | | | | polyol composition |
| Endurathane SR43S | | 110 | 3.2 | 31-34 | 1.12-1.24 | 320-360 | 325-615 | 1.0-1.2 | Cream time: 3-5 s |
| (Polymer Group | | | | | (@21° C.) | (@21° C.) | | | Gel time: 8-14 s |
| Limited, New | | | | | | | | | Fast reacting |
| Zealand) | | | | | | | | | polyol composition |
| R-Foam 200 | | 340 | 0.08 | 192 ± 4 | | | 320-800 | 1.9-4.8 | Cream time: 65 s |
| (Barnes, New South | | | | | | | | | Gel time: 180 s |
| Wales, Australia) | | | | | | | | | High-density |
| | | | | | | | | | polyol composition |
| R-Foam 100 | Polyether | 300 | 0.08 | 96 ± 2 | | | 300-480 | 1.6-2.6 | Cream time: 60 s |
| (Barnes, New South | polyol | | | | | | | | Gel time: 150 s |
| Wales, Australia) | | | | | | | | | High-density |
| | | | | | | | | | polyol composition |
| Ecofoam GP330 | Polyether | | | 38-40 | 1.12-1.14 | 150-250 | | | Cream time: 35 s |
| (Era Polymers Pty. | polyol | | | | (@25° C.) | (@25° C.) | | | Gel time: 145 s |
| Ltd Australia) | | | | | | | | | |
| Foam-iT! 10 | | 430 | <0.05 | 160 | 0.16 | 400 | 370-600 | 2.8-4.6 | Cream time: 90 s |
| rigid castable | | | | | | (@23° C.) | | | Gel time: 150 s |
| polyol | | | | | | | | | High-density |
| | | | | | | | | | polyol composition |
| Foam-iT! 5 | | 390 | <0.05 | 80 | 0.08 | 300 | 370-600 | 2.6-4.2 | Cream time: 90 s |
| rigid castable | | | | | | (@23° C.) | | | Gel time: 150 s |
| polyol | | | | | | | | | High-density |
| | | | | | | | | | polyol composition |

TABLE 2
Isocyanate composition properties

| | | NCO | Average | | Acidity | Viscosity @ |
|---|---|---|---|---|---|---|
| Isocyanate | Isocyanate | content | isocyanate | Density | as HCL | 25° C. |
| composition name | type | (%) | functionality | (g/cm³) | (mg/kg) | (mPa · s) |
| Endurathane Part A | Polymeric | 30.5-32 | 2.6-2.7 | 1.22-1.25 | | 170-270 |
| Isocyanate Component | diphenylmethane | | | | | |
| (Polymer Group | diisocyanate | | | | | |
| Limited, | | | | | | |
| New Zealand) | | | | | | |
| Ecofoam GP330 | Polymeric | | | 1.22-1.26 | | 150-250 |
| isocyanate | diphenylmethane | | | | | |
| (Era Polymers Pty. | diisocyanate | | | | | |
| Ltd Australia) | | | | | | |

TABLE 3
Thermophysical properties of PT4, PT6, PT8, PT23, PT24, PT−15, RT4, RT21 and RT25HC.

| | PT 4 | PT 6 | PT 8 | PT 20 | PT 23 | PT 24 | PT −15 | RT 4 | RT21 | RT25HC |
|---|---|---|---|---|---|---|---|---|---|---|
| Peak melting | 4.4 | 6.2 | 7.5 | 20.2 | 24.3 | 23.1 | −15.1 | 4.5 | 24.6 | 25.7 |
| point (° C.) (DSC | | | | | | | | | | |
| measurement) | | | | | | | | | | |
| Average Heat | 183.4 | 128.1 | 153.6 | 166.2 | 206.4 | 161.9 | 223.9 | 146.8 | 133.8 | 187.2 |
| storage capacity | | | | | | | | | | |
| (kJ/kg) (DSC | | | | | | | | | | |
| measurement) | | | | | | | | | | |
| Thermal | 0.15-0.25 | — | 0.14-0.22 | 0.14-0.23 | 0.15-0.25 | 0.15-0.25 | 0.55-2.34 | 0.2 | 0.2 | 0.2 |
| conductivity | | | | | | | | | | |
| (W/mK) | | | | | | | | | | |
| Density (kg/m³) | 880-960 | 860 | 860-950 | 860-950 | 830-910 | 860-950 | 1030-1130 | 770-880 | 770-880 | 770-880 |
| (liquid-solid) | | | | | | | | | | |
| Specific heat | 2.26-1.78 | 1.73-1.56 | 2.15-1.85 | 2.15-2.07 | 1.99-1.84 | 3.04-2.85 | 2.06-1.84 | 2 | 2 | 2 |
| (kJ/kg · K) | | | | | | | | | | |

TABLE 4
Thermophysical properties of tetradecane,
octadecane and butyl stearate.

| | | | Butyl |
|---|---|---|---|
| | Tetradecane | Octadecane | stearate |
| Peak melting point (° C.) | 8.0 | 31.2 | 21.9 |
| (DSC measurement) | | | |
| Average Heat storage capacity | 205.3 | 217.2 | 128.3 |
| (kJ/kg) (DSC measurement) | | | |
| Molecular formula | C₁₄H₃₀ | C₁₈H₃₈ | C₂₂H₄₄O₂ |
| Density (kg/m³) | 861 | 777 | 861 |
| Molecular weight (g/mol) | 198.4 | 254.5 | 340.6 |

### Example 1

Composite 1A was prepared comprising components shown in Table 5 according to the following method. Components A and B were mixed in a 1:1 (by volume) ratio and applied to a flat surface for curing via a heated hose high-pressure plural airless spray system. Curing temperature was between 25 and 40° C. The cream time was between 4 and 7 seconds. The mass fraction of PCM in the composition was 25%. The composition was left to fully cure and form a rigid polyurethane foam composite. A thermal stability test of the Composite 1A showed a mass loss of less than 1%.

Composite 1B was prepared according to the method for 1A, except that the mass fraction of PCM in the composition was 30%. The thermal stability test of Composite 1B showed a mass loss of 6.3%, and mass loss continued following the initial period of three days. The difference in mass loss, and therefore stability, suggests that for rigid foam composites the amount of PCM should not exceed 25 weight % if the polyol composition is limited to a fast reacting polyol.

TABLE 5

| | |
|---|---|
| Composite 1A | Composite 1B |

| | |
|---|---|
| Ingredient | Weight (%) |

Component A

| | | |
|---|---|---|
| Endurathane Part A | 37.5 | 35 |

Component B

| | | |
|---|---|---|
| Endurathane SR42M | 37.5 | 35 |
| PureTemp ® 24 | 25 | 30 |
| Mass loss (%) | <1% | 6.3 |

### Example 2

Composite 2 was prepared with components shown in Table 6 according to the following method. Components A and B were mixed in a 1:1 (by volume) ratio and applied to a flat surface for curing via a heated hose high-pressure plural airless spray system. The composition was left to fully cure and form a rigid polyurethane foam composite. Curing temperature was between 25 and 40° C. The cream time was between 60 and 70 seconds. The mass fraction of PCM in the composite was 25%. A thermal stability test of the cured composite showed a mass loss of greater than 1.5%. The composite exhibited a considerable drop in energy density following the long-term thermal stability tests conducted on the sample.

TABLE 6
Composite 2

| | |
|---|---|
| Ingredient | Weight (%) |

Component A

| | |
|---|---|
| Ecofoam GP330 Isocyanate | 37.5 |

Component B

| | |
|---|---|
| GP330 polyether polyol | 37.5 |
| PureTemp ® 24 | 25 |

### Example 3

Composites comprising 50 wt. % (Composite 3) and 40 wt. % PCM (Composite 4) were prepared with components shown in Table 7. For composites 3 and 4, components A and B were mixed in a 1:1 (by volume) ratio and applied to a flat surface for curing via a heated hose high-pressure plural airless spray system. The compositions were left to fully cure and form a rigid polyurethane foam composite. Curing temperature was between 25 and 40° C. The cream time for each composite was less than 10 seconds.

Thermal stability tests of the cured composites showed a mass loss of less than or equal to 1%.

TABLE 7

| | | Composite 3 | Composite 4 |
|---|---|---|---|
| | Ingredient | Weight (%) | Weight (%) |
| Component A | | | |
| | Endurathane Part A | 25 | 30 |
| Component B | | | |
| | Endurathane SR42M | 12.5 | 15 |
| | R-Foam 200 polyol | 12.5 | 15 |
| | PureTemp ® 24 | 50 | 40 |

### Example 4

Composites 3 and 4 (described in Example 3) were prepared and applied via conventional polyurethane spray-application technique directly to a paper-lined plasterboard wall board. The cream times of the composite formulations were observed to be between 4 and 7 seconds, and the gel times were observed to be between 8 and 10 seconds. The composites were allowed to cure to form a cured composite adhered to the board.

Fully cured composites were subjected to the temperature stability test protocol described herein. Data on the composites' performance is shown in Table 8 below.

TABLE 8
PMT: peak melting temperature, as determined by DSC; Ave ΔH: Average
energy density (i.e.(ΔH_{melting} + ΔH_{freezing})/2),

| | | | | | | Volumetric |
|---|---|---|---|---|---|---|
| | | | Ave ΔH | Mass | Composite | energy |
| | PCM | PMT | (kJ/kg | loss | Density | density |
| Composite | (wt. %) | (° C.) | (kJ/kg) | (wt. %) | (kg/m³) | (kJ/m³) |
| Composite | 50 | 24.94 | 74.40 | 0.54 | 278 | 20683 |
| 3 | | | | | | |
| Composite | 40 | 24.77 | 65.98 | 0.61 | 239 | 15769 |
| 4 | | | | | | |

### Example 5

Composite 6 and 7 were prepared with components shown in Table 9 according to the following method. Components A and B were mixed in a 1:1 (by volume) ratio and applied to a flat surface for curing via a heated hose high-pressure plural airless spray system. The compositions were left to fully cure and form a rigid polyurethane foam composite. Curing temperature was between 25 and 40° C. The cream time was less than 10 seconds. The mass fraction of PCM in the Composites 6 and 7 were 40 wt %. A thermal stability test of the cured composites showed a mass loss of less than or equal to 1%.

TABLE 9

| | |
|---|---|
| Composite 6 | Composite 7 |

| | |
|---|---|
| Ingredient | Weight (%) |

Component A

| | | |
|---|---|---|
| Endurathane Part A | 30 | 30 |

Component B

| | | |
|---|---|---|
| Endurathane SR42M | 15 | 15 |
| R-Foam 200 polyol | 15 | 15 |
| PureTemp ® 4 | 40 | — |
| PureTemp −15 | — | 40 |

### Example 6

Composites 9, 10 and 11 were prepared by combining Component A and Component B, having the compositions shown in Table 10, below, via a heated hose high-pressure plural airless spray system, and allowed to fully cure. The polyurethane formulations were observed to have cream times of between 2 to 3 minutes. The composites lost a substantial amount of mass during mass loss testing. Cured composites 9, 10 and 11 were coated with a polyurethane epoxy resin to attempt to reduce leakage and/or mass loss. The coated composites were washed with hexane for 2 hours before placing in the oven at 50° C. for 30 days. As shown in Table 10 and FIG. 6, up to 6.7 wt. % mass loss was observed.

The result showed that coating was not a feasible solution to PCM leakage from polyurethane foams. Generally, the results revealed considerable mass loss, higher percentage drop in energy density (based on differential scanning calorimetry experiments) and poor-quality composite appearance.

TABLE 10

| Components | | | |
|---|---|---|---|
| | Composite 9 | Composite 10 | Composite 11 |
| Ingredient | Weight (%) | Weight (%) | Weight (%) |
| Component A | 1:1 | 1:1.5 | 1.5:1 |
| Endurathane Part A | 37.5 | 37.5 | 37.5 |
| Component B | | | |
| Endurathane SR42M | 18.75 | 15 | 22.5 |
| Ecofoam GP330 | 18.75 | 22.5 | 15 |
| polyether polyol | | | |
| Rubitherm RT25HC | 25 | 25 | 25 |
| Mass loss (%)* | 12.12 | 5.2 | 5.4 |
| Mass loss after coating | 6.69 | 4.35 | 4.21 |

*mass loss determined according to the thermal stability protocol described herein.

### Example 7

Cured Composites 12 to 40 having the properties described in Tables 11-16 were prepared according to standard methodology. Polyol A is a fast reacting polyol (FRP) composition and polyol B is a high density polyol (HDP) composition.

TABLE 11
Ave ΔH: Average energy density (i.e. (ΔH_{melting} + ΔH_{freezing})/2), PMT/PFT: peak melting temperature/peak freezing temperature.

| | PCM | | | | | | | | | |
|---|---|---|---|---|---|---|---|---|---|---|
| | Butyl stearate | | | | | | | | | |
| | Pure | | | | | | | | | |
| | butyl | | | | | | | | | |
| Composite No. | stearate | 12 | 13 | 14 | 15 | 16 | 17 | 18 | 19 | 20 |
| Polyol A/B | — | — | — | 1:1 | 1:1.5 | 1:2 | 1:3 | 1.5:1 | 2:1 | 3:1 |
| Polyol A (SR42M) | — | 25 | 0 | 12.5 | 10 | 8.3 | 6.25 | 15 | 16.7 | 18.75 |
| (wt. %) | | | | | | | | | | |
| Polyol B (R-Foam 200 | — | 0 | 25 | 12.5 | 15 | 16.7 | 18.75 | 10 | 8.3 | 6.25 |
| polyol) (wt. %) | | | | | | | | | | |
| Isocyanate | — | 25 | 25 | 25 | 25 | 25 | 25 | 25 | 25 | 25 |
| (Endurathane | | | | | | | | | | |
| Part A) | | | | | | | | | | |
| (wt. %) | | | | | | | | | | |
| PCM (wt. %) | — | 50 | 50 | 50 | 50 | 50 | 50 | 50 | 50 | 50 |
| Cream time (s) | | | | 14 | 10 | | 12 | 7 | | 10 |
| Tack free | | | | 70 | 68 | | 67 | 72 | | 68 |
| time (s) | | | | | | | | | | |
| Rise time (s) | | | | 47 | 45 | | 87 | 72 | | 53 |
| Max foam | | | | 83 | 82.3 | | 73.5 | 74.4 | | 78.9 |
| temp (° C.) | | | | | | | | | | |
| Max temp | | | | 248 | 376 | | 230 | 229 | | 260 |
| time (s) | | | | | | | | | | |
| Ave ΔH | 128.3 | 40.0 | 42.6 | 56.7 | 55.2 | 54.4 | 59.4 | 58.8 | 58.1 | 51.5 |
| (kJ/kg) | | | | | | | | | | |
| PMT/PFT | 21.9/20.7 | 23.4/15.0 | 6.3 | 23.9/16.8 | 25.1/16.5 | 23.2/16.0 | 23.6/16.3 | 24.1/16.8 | 24.6/16.8 | 22.8/17.0 |
| (° C.) | | | | | | | | | | |
| Mass loss (%) | >1.0 | >1.0 | >1.0 | <1.0 | <1.0 | >1.0 | <1.0 | <1.0 | <1.0 | >1.0 |
| Sample | — | Oily | Oily | Dry | Dry | Partial | Dry | Dry | Dry | Partial |
| appearance | | surface | surface | smooth | smooth | oily | smooth | smooth | smooth | oily |
| | | | | surface | surface | surface | surface | surface | surface | surface |

TABLE 12
Ave ΔH : Average energy density (i.e.(ΔH_{melting} + ΔH_{freezing})/2),
PMT/PFT: peak melting temperature/peak freezing temperature.

| | PCM | | | | | | | | | |
|---|---|---|---|---|---|---|---|---|---|---|
| | Tetradecane (C₁₄) | | | | | | | | | |
| | Pure | | | | | | | | | |
| Composite No. | C₁₄^{a} | 21 | 22 | 23 | 24 | 25 | 26 | 27 | 28 | 29 |
| Polyol A/B | — | — | — | 1:1 | 1:1.5 | 1:2 | 1:3 | 1.5:1 | 2:1 | 3:1 |
| Polyol A (SR42M) | — | 25 | 0 | 12.5 | 10 | 8.3 | 6.25 | 15 | 16.7 | 18.75 |
| (wt. %) | | | | | | | | | | |
| Polyol B (R-Foam | — | 0 | 25 | 12.5 | 15 | 16.7 | 18.75 | 10 | 8.3 | 6.25 |
| 200 polyol) (wt. %) | | | | | | | | | | |
| Isocyanate | | 25 | 25 | 25 | 25 | 25 | 25 | 25 | 25 | 25 |
| (Endurathane | | | | | | | | | | |
| Part A) | | | | | | | | | | |
| (wt. %) | | | | | | | | | | |
| PCM (wt. %) | — | 50 | 50 | 50 | 50 | 50 | 50 | 50 | 50 | 50 |
| Cream time (s) | | | 35 | 13 | 11 | | 11 | 4 | | 8 |
| Tack free | | | 230 | 12 | 19 | | 28 | 11 | | 9 |
| time (s) | | | | | | | | | | |
| Rise time (s) | | | 110 | 24 | 35 | | 61 | 21 | | 18 |
| Ave ΔH | 205.3 | | 15.9 | 44.6 | 81.6 | 28.8 | 67.4 | 104.3 | 93.9 | 114.8 |
| (kJ/kg) | | | | | | | | | | |
| PMT/PFT | 8.0/2.8 | | 10.6/3.0 | 7.9/3.0 | 8.9/1.8 | 9.8/2.4 | 11.2/2.8 | 11.1/1.8 | 9.8/0.7 | 9.5/1.5 |
| (° C.) | | | | | | | | | | |
| Mass loss (%) | | — | >1.0 | >1.0 | ~1.0 | >1.0 | >1.0 | <1.0 | ~1.0 | <1.0 |
| Sample | — | Oily | Oily | Partial | Dry | Oily | Partial | Dry | Dry | Dry |
| appearance | | surface | surface | oily | smooth | surface | oily | smooth | smooth | smooth |
| | | | | surface | surface | | surface | surface | surface | surface |

TABLE 13
Ave ΔH: Average energy density (i.e.(ΔH_{melting} + ΔH_{freezing})/2),
PMT/PFT: peak melting temperature/peak freezing temperature.

| | PCM | | |
|---|---|---|---|
| | Octadecane | | |
| Composite No. | Pure C₁₈^{a} | 30 | 31 |
| Polyol A/B | — | 1:1.5 | 1.5:1 |
| Polyol A (SR42M) (wt. %) | — | 10 | 16.7 |
| Polyol B (R-Foam 200 polyol) (wt. %) | — | 15 | 8.3 |
| Isocyanate (Endurathane Part A) (wt. %) | — | 25 | 25 |
| PCM (wt. %) | — | 50 | 50 |
| Cream time (s) | | 10 | 6 |
| Tack free time (s) | | 8 | 14 |
| Rise time (s) | | 17 | 24 |
| Ave ΔH (kJ/kg) | 217.2 | 97.0 | 122.5 |
| PMT/PFT (° C.) | 31.2/23.5 | 32.9/24.2 | 34.1/25.4 |
| Mass loss (%) | | <1.0 | <1.0 |
| Sample appearance | — | Dry smooth surface | Dry smooth surface |

TABLE 14
Ave ΔH: Average energy density (i.e.(ΔH_{melting} + ΔH_{freezing})/2),
PMT/PFT: peak melting temperature/peak freezing temperature.

| | PCM | | | |
|---|---|---|---|---|
| | RT4 (paraffin based PCM) | | | |
| Composite No. | Pure RT4^{a} | 32 | 33 | 34 |
| Polyol A/B | — | 1/1 | 1.5/1 | 1/1.5 |
| Polyol A (SR42M) (wt. %) | — | 12.5 | 15 | 10 |
| Polyol B (R-Foam 200 polyol) (wt. %) | — | 12.5 | 10 | 15 |
| Isocyanate (Endurathane Part A) (wt. %) | — | 25 | 25 | 25 |
| PCM (wt. %) | — | 50 | 50 | 50 |
| Total weight (g) | — | 450 | 450 | 450 |
| Cream time (s) | | 15 | 7 | 9 |
| Tack free time (s) | | 37 | 19 | 20 |
| Rise time (s) | | 45 | 59 | 13 |
| Ave ΔH (kJ/kg)) | 146.8 | 54.9 | 86.9 | 67.1 |
| PMT/PFT (° C.) | 4.5/2.8 | 6.9/0.0 | 5.0/-0.3 | 4.5/1.1 |
| Mass loss (%) | | >1.0 | <1.0 | <1.0 |
| Sample appearance | — | Partial oily | Dry smooth | Dry smooth |
| | | smooth surface | surface | surface |

TABLE 15
Ave ΔH: Average energy density (i.e. (ΔH_{melting} + ΔH_{freezing})/2),
PMT/PFT: peak melting temperature/peak freezing temperature.

| | PCM | | | |
|---|---|---|---|---|
| | PT24 (organic, non-paraffin based PCM) | | | |
| Composite No. | Pure PT24^{a} | 35 | 36 | 37 |
| Polyol A/B | — | 1:1 | 1:1 | 1:1 |
| Polyol A (SR42M) (wt. %) | — | 16.65 | 15 | 12.5 |
| Polyol B (R-Foam 200 polyol) (wt. %) | — | 16.65 | 15 | 12.5 |
| Isocyanate (Endurathane Part A) (wt. %) | — | 33.3 | 30 | 25 |
| PCM (wt. %) | — | 33.3 | 40 | 50 |
| Cream time (s) | | 6 | 7 | 9 |
| Tack free time (s) | | 37 | 38 | 38 |
| Rise time (s) | | 66 | 67 | 90 |
| Ave ΔH (kJ/kg) | 164.3 | 54.5 | 66 | 74.4 |
| PMT/PFT (° C.) | 23.1/16.8 | 24.6/18.0 | 24.1/24.8 | 25.2/24.9 |
| Mass loss (%) | | <1.0 | <1.0 | <1.0 |
| Sample appearance | — | Dry smooth | Dry smooth | Dry smooth |
| | | surface | surface | surface |

TABLE 16
Ave ΔH: Average energy density (i.e.(ΔH_{melting} + ΔH_{freezing})/2),
PMT/PFT: peak melting temperature/peak freezing temperature.

| | PCM | | | | | |
|---|---|---|---|---|---|---|
| | Organic, non-paraffin based PCMs | | | | | |
| | PCM: PT4 | | PCM: PT6 | | PCM: PT8 | |
| | Pure | | Pure | | Pure | |
| Composite No. | PT4^{a} | 38 | PT6^{b} | 39 | PT8^{c} | 40 |
| Polyol A/B | — | 1:3 | — | 1:3 | — | 1:3 |
| Polyol A (SR42M) | — | 6.25 | — | 6.25 | — | 6.25 |
| (wt. %) | | | | | | |
| Polyol B (R-Foam | — | 18.75 | — | 18.75 | — | 18.75 |
| 200 polyol) (wt. %) | | | | | | |
| Isocyanate | — | 25 | — | 25 | — | 25 |
| (Endurathane | | | | | | |
| Part A) | | | | | | |
| (wt. %) | | | | | | |
| PCM (wt. %) | — | 50 | — | 50 | — | 50 |
| Cream time (s) | | 12 | | 14 | | 15 |
| Tack free | | 19 | | 19 | | 24 |
| time (s) | | | | | | |
| Rise time (s) | | 36 | | 53 | | 54 |
| Ave ΔH | 183.4 | 84.2 | 128.1 | 86.4 | 153.6 | 96.9 |
| (kJ/kg) | | | | | | |
| PMT/PFT | 4.4/−1.02 | 7.2/−2.5 | 6.2/0.8 | 7.2/−1.4 | 7.5/1.3 | 11.8/−0.3 |
| (° C.) | | | | | | |
| Mass loss (%) | | <1.0 | | <1.0 | | <1.0 |
| Sample | — | Dry | — | Dry | — | Dry |
| appearance | | smooth | | smooth | | smooth |
| | | surface | | surface | | surface |

### Example 8

Cured composites 41 to 65 having the properties described in Tables 17 and 18 were prepared according to standard methodology. As with composites 1A and 1B, composite 41 comprised a single fast reacting polyol and no high density polyol. Composites 1B and 41 comprised PCM amount of greater than 25 weight %, and underwent considerable mass loss in testing, whereas composite 1A (comprising PCM of 25%) provided a good quality product. The difference in mass loss, and therefore stability between composite 1A on the one hand and composites 1B and 41 on the other, suggests that, for rigid foam composites, amount of PCM should not exceed 25 weight % if the polyol composition is limited to fast reacting polyol.

Composites 51-53 and 63-65 comprise the combination of two separate fast reacting polyol compositions, and were found undergo continued mass loss following an initial period, to be of lower quality, and reduced energy density compared to the composites prepared by the combination of a fast reacting polyol composition and a high density polyol composition. Whilst the other composites (comprising the combination of a fast reacting polyol composition and a high density polyol composition) underwent various levels of initial mass loss, the mass loss was generally considered to stabilise following the initial period.

TABLE 17
Ave ΔH: Average energy density (i.e.(ΔH_{melting} + ΔH_{freezing})/2), PMT/PFT: peak melting temperature/peak freezing temperature.

| | | | | Polyol | | | | | | | | | | |
|---|---|---|---|---|---|---|---|---|---|---|---|---|---|---|
| | | | | A/B | | | Isocy- | | Cream | Rise | Ave | | Mass | Sample |
| Compos- | Polyol | Polyol | Isocy- | (weight | Polyol | Polyol | anate | PCM | time | time | ΔH | PMT/PFT | loss | appear- |
| ite No. | A | B | anate | ratio) | A (g) | B (g) | (g) | (g) | (s) | (s) | (kJ/kg) | (° C.) | (%) | ance |
| Pure | | | | | | | | | | | 133.8 | 24.6/21.4 | | |
| RT21 | | | | | | | | | | | | | | |
| 41 | SR42M | — | Endurathane | 1:0 | 10 | 0 | 10 | 8.55 | — | — | — | — | 8.7 | Poor |
| 42 | SR43S | RF100 | Part A | 1:2 | 1.67 | 3.33 | 5 | 10 | 55 | 60 | 52.1 | 25.8/14.5 | 4.21 | Rigid, oily |
| | | | | | | | | | | | | | | surface |
| 43 | SR43S | RF100 | | 2:1 | 3.33 | 1.67 | 5 | 10 | 30 | 53 | 18.11 | 25/13.8 | 1.65 | Rigid, dry |
| | | | | | | | | | | | | | | surface |
| 44 | SR43S | RF100 | | 3:1 | 3.75 | 1.25 | 5 | 10 | 28 | 42 | 57.63 | 26.1/16.2 | 2.09 | Rigid, dry |
| | | | | | | | | | | | | | | surface |
| 45 | SR43S | F-iT 5 | | 1:2 | 1.67 | 3.33 | 5 | 10 | 25 | 50 | 100.36 | 23.9/14.0 | 1.38 | Rigid, dry |
| | | | | | | | | | | | | | | smooth |
| | | | | | | | | | | | | | | surface |
| 46 | SR43S | F-iT 5 | | 2:1 | 3.33 | 1.67 | 5 | 10 | 20 | 46 | 72.68 | 26.0/14.2 | 1.94 | Rigid, dry |
| | | | | | | | | | | | | | | smooth |
| | | | | | | | | | | | | | | surface |
| 47 | SR43S | F-iT 5 | | 3:1 | 3.75 | 1.25 | 5 | 10 | 19 | 47 | 41.73 | 24.3/17.4 | 2.25 | Oily surface |
| 48 | SR43S | F-iT10 | | 1:2 | 1.67 | 3.33 | 5 | 10 | 45 | 51 | 51.26 | 24.7/14.8 | 4.14 | Rigid oily |
| | | | | | | | | | | | | | | surface |
| 49 | SR43S | F-iT10 | | 2:1 | 3.33 | 1.67 | 5 | 10 | 37 | 35 | 104.42 | 26.9/14.2 | 1.55 | Rigid dry |
| | | | | | | | | | | | | | | surface |
| 50 | SR43S | F-iT10 | | 3:1 | 3.75 | 1.25 | 5 | 10 | 43 | 37 | 102.29 | 24.5/15.6 | 2.1 | Rigid dry |
| | | | | | | | | | | | | | | surface |
| 51 | SR435 | SR42M | | 1:2 | 1.67 | 3.33 | 5 | 10 | 10 | 20 | 59.45 | 24.1/15 | 2.64 | Poor |
| 52 | SR435 | SR42M | | 2:1 | 3.33 | 1.67 | 5 | 10 | 20 | 30 | 56.36 | 23.5/16.7 | 3.23 | Poor |
| 53 | SR43S | SR42M | | 3:1 | 3.75 | 1.25 | 5 | 10 | 15 | 25 | 41.62 | 24.5/17.5 | 4.21 | Poor |

TABLE 18
Ave ΔH: Average energy density (i.e.(ΔHmelting + ΔHfreezing)/2), PMT/PFT: peak melting temperature/peak freezing temperature.

| | | | | Polyol | | | | | | | | | | |
|---|---|---|---|---|---|---|---|---|---|---|---|---|---|---|
| | | | | A/B | | | Isocy- | | Cream | Rise | Ave | | Mass | Sample |
| Compos- | Polyol | Polyol | Isocy- | (weight | Polyol | Polyol | anate | PCM | time | time | ΔH | PMT/PFT | loss | appear- |
| ite No. | A | B | anate | ratio) | A (g) | B (g) | (g) | (g) | (s) | (s) | (kJ/kg) | (° C.) | (%) | ance |
| Pure | | | | | | | | | | | 146.8 | 4.5/2.8 | | |
| RT4 | | | | | | | | | | | | | | |
| 54 | SR43S | RF100 | Endurathane | 1:2 | 1.67 | 3.33 | 5 | 10 | 55 | 61 | 42.11 | 8.8/0.17 | 4 | Rigid, oily |
| | | | Part A | | | | | | | | | | | surface |
| 55 | SR43S | RF100 | | 2:1 | 3.33 | 1.67 | 5 | 10 | 35 | 35 | 69.89 | 9.2/−1.9 | 2.8 | Rigid, dry |
| | | | | | | | | | | | | | | surface |
| 56 | SR43S | RF100 | | 3:1 | 3.75 | 1.25 | 5 | 10 | 35 | 45 | 62.42 | 9.5/−1.2 | 3.2 | Rigid, dry |
| | | | | | | | | | | | | | | surface |
| 57 | SR43S | F-iT 5 | | 1:2 | 1.67 | 3.33 | 5 | 10 | 55 | 52 | 82.67 | 8.1/−1.7 | 2.2 | Rigid, dry |
| | | | | | | | | | | | | | | smooth |
| | | | | | | | | | | | | | | surface |
| 58 | SR43S | F-iT 5 | | 2:1 | 3.33 | 1.67 | 5 | 10 | 45 | 60 | 77.76 | 12.5/5.0 | 2 | Rigid, dry |
| | | | | | | | | | | | | | | smooth |
| | | | | | | | | | | | | | | surface |
| 59 | SR43S | F-iT 5 | | 3:1 | 3.75 | 1.25 | 5 | 10 | 35 | 45 | 12.32 | 7.5/1.1 | 2.5 | Rigid, oil |
| | | | | | | | | | | | | | | surface |
| 60 | SR435 | F-iT10 | | 1:2 | 1.67 | 3.33 | 5 | 10 | 80 | 90 | 5.87 | 7.7/3.1 | 2.6 | Rigid, oily |
| | | | | | | | | | | | | | | surface |
| 61 | SR43S | F-iT10 | | 2:1 | 3.33 | 1.67 | 5 | 10 | 45 | 90 | 93.55 | 10.6/−4.4 | 2.1 | Rigid dry |
| | | | | | | | | | | | | | | surface |
| 62 | SR43S | F-iT10 | | 3:1 | 3.75 | 1.25 | 5 | 10 | 50 | 36 | 82.83 | 9.2/−1.7 | 1.9 | Rigid, dry |
| | | | | | | | | | | | | | | smooth |
| | | | | | | | | | | | | | | surface |
| 63 | SR43S | SR42M | | 1:2 | 1.67 | 3.33 | 5 | 10 | 25 | 21 | 29.09 | 9.3/2.0 | 15 | Poor |
| 64 | SR43S | SR42M | | 2:1 | 3.33 | 1.67 | 5 | 10 | 20 | 35 | 41.58 | 11.3/4.6 | 6.2 | Poor |
| 65 | SR43S | SR42M | | 3:1 | 3.75 | 1.25 | 5 | 10 | 10 | 24 | 51.41 | 8.1/−0.1 | 4.4 | Poor |

### Example 9—Mechanical Strength

Rigid polyurethane foam composites prepared by the combination of an isocyanate composition, fast reacting polyol composition, high density polyol composition and PCM were tested for flexural strength according to ASTM C 293.

FIG. 7 shows that increasing PCM content decreases the flexural strength. The measured strength of the composites comprising 40 wt. % and 50 wt. % PCM was considered acceptable for rigid polyurethane foam uses. There was a notable decrease in strength observed between composites comprising 50 wt. % and 60 wt. %.

### Example 10—Thermal Durability Tests

A rigid polyurethane foam composite sample was prepared by the combination of an isocyanate composition, fast reacting polyol composition, high density polyol composition and PCM (50 weight %). The sample was subjected to thermal cycling between 7 and 45° C. for 8 months in a temperature-controlled chamber and the variation of phase transition temperatures of the samples were recorded. Thermal measurements of the samples during the thermal cycling indicated the phase change transition regions were identical after repeated heating and cooling cycles between 7 and 45° C. for a period of 8 months.

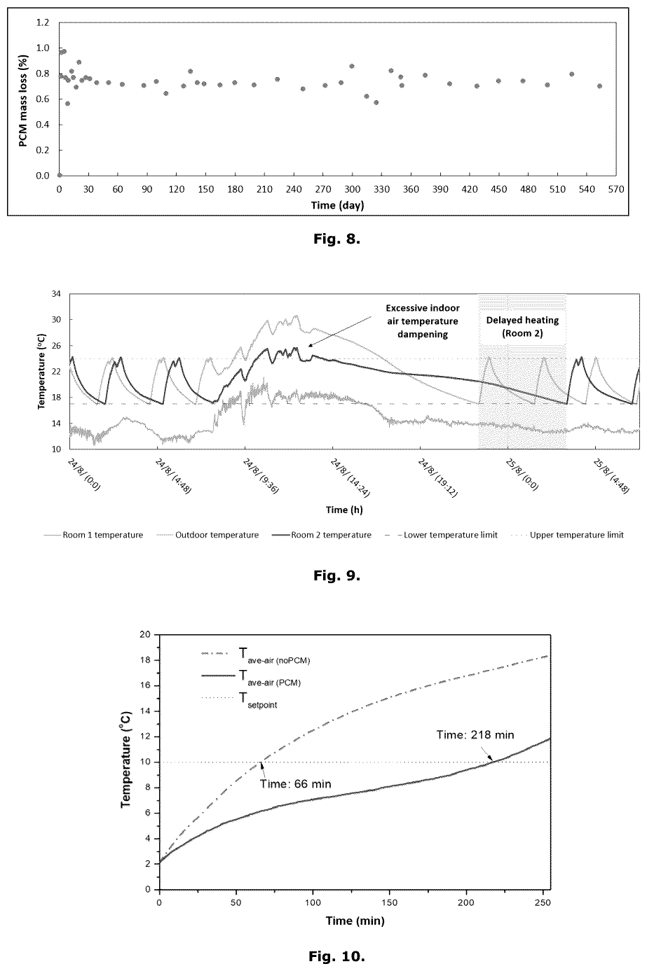

Weight measurements of the sample were taken while the sample was subjected to continuous heating at 50° C. for 554 days. Results are shown in FIG. 8. The result revealed that the sample underwent mass loss of 0.97 wt. % of its initial weight within the first 6 days before stabilising with no further loss recorded. This result is indicative of a composite material in which the PCM is well encapsulated by the polyurethane.

### Example 11—Building Insulation Activity

Modified gypsum wallboards were prepared by applying the polyurethane composite of the present invention to one side of standard gypsum wallboard. The polyurethane composite was prepared according to the methods described herein, wherein the PCM was a heptadecane-based non-encapsulated PCM (melting point of 21° C.) in an amount of 50 wt. % based on the composite weight, the fast reacting polyol composition was SR42M polyol, the high density polyol composition was R-Foam 200, the FRP/HDP blend ratio was 2:1 (by weight) and the isocyanate was Endurathane Part A Isocyanate Component.

The gypsum wallboard modified with the composite was installed in a test building, and the temperature of the test building was compared with the temperature of an identically dimensioned control building built with standard gypsum wallboard. The interior dimension of each building was 2400 mm×2400 mm×2400 mm.

The internal building temperature in the test and control buildings is shown alongside the outdoor temperature in FIG. 9. Both buildings were subjected to similar heating conditions through active means. Heating controllers in both buildings were set to automatically switch on if the temperature dropped below 17° C. and switch off when the temperature at temperatures at or above 24° C. FIG. 9 shows the insulating effect of the modified gypsum wallboard as the internal building temperature of the test building decreased slower than that of the control building.

### Example 12—Cold Storage Insulation Activity

A polyurethane composite of the present invention was prepared according to the method in Example 11, except the PCM was Rubitherm RT 4 PCM (a non-encapsulated PCM with a melting point 4° C.) and the FRP and HDP blend has a mass ratio of 1.5:1. The composite was applied to the walls and ceiling of a 240 litre refrigerator (Westinghouse® model WRM2400WD).

The internal temperature of the unpowered refrigerator was monitored in the presence and absence of the composite in FIG. 10. As shown, the heating rate of the unpowered refrigerator without composite foam was 0.12ºC/min, compared to 0.04° C./min where the composite was applied.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A rigid foam composite comprising:
a. a polyurethane; and
b. a phase change material (PCM);
wherein the PCM is present in the composite at a concentration of greater than 25 weight % relative to the weight of the composite.

2. The composite of claim 1, wherein the PCM is present in the composite in an amount between 25 to 60 weight %.

3. The composite of claim 1 or 2, wherein the PCM is distributed through the composite.

4. The composite of any one of the preceding claims, wherein the density of the composite is at least 200 kg/m³.

5. The composite of any one of the preceding claims, wherein, after an initial mass loss period, the composite exhibits further mass loss of less than 1 wt. %.

6. The composite of any one of the preceding claims, wherein the energy density of the composite is at least 50 KJ/kg.

7. The composite of any one of the preceding claims, comprising the reaction product of a mixture, wherein the mixture comprises the PCM, an isocyanate composition, a fast-reacting polyol composition and a high density polyol composition.

8. The composite of claim 7, wherein the mixture has a cream time of less than 60 seconds.

9. The composite of claim 7 or 8, wherein the isocyanate composition has an isocyanate content of at least 30%.

10. The composite of any one of claims 7-9, wherein the fast reacting polyol composition and the high density polyol composition are present in the mixture at a ratio of between 3:1 and 1:3 (by weight).

11. The composite of any one of the preceding claims wherein the PCM is a non-encapsulated PCM.

12. The composite of any one of the preceding claims, wherein the PCM is selected from the group consisting of hydrocarbons (paraffins), fatty acids, and fatty acid esters.

13. A method for the preparation of a rigid foam composite comprising a polyurethane and a phase change material (PCM), the method comprising the combination of a fast reacting polyol composition, a high density polyol composition, an isocyanate composition, and a PCM, to produce the rigid foam composite, wherein the total weight of the PCM is at least 25% of the total weight of the composite.

14. The method of claim 13, wherein the isocyanate composition has an isocyanate content of at least 30%.

15. The method of claim 13 or 14, wherein the fast reacting polyol composition and high density polyol composition are combined in a ratio of between 3:1 and 1:3 (by weight).

16. The method of any one of claims 13 to 15, wherein the reaction between the fast reacting polyol composition, high density polyol composition and isocyanate composition has a cream time of less than 60 seconds.

17. The method of any one of claims 13 to 16, further comprising the combination of one or more of catalysts, blowing agents, and fire retardants.

18. A rigid foam composite prepared according to the method of any one of claims 13 to 17.

19. A kit for preparing a rigid foam composite, the kit comprising:
a fast reacting polyol composition;
a high density polyol composition;
an isocyanate composition; and
a phase change material (PCM);
wherein the PCM is present in an amount greater than 25 weight % relative to the total weight of the fast reacting polyol composition, high density polyol composition and isocyanate composition.
